(19) United States
(12) Patent Application Publication
(10) Pub. No.: US 2012/0177978 A1
(43) Pub. Date: Jul. 12, 2012

(54) SECONDARY BATTERY, METHOD OF ASSEMBLING THE SAME, AND BATTERY PACK INCLUDING THE SECONDARY BATTERY

(76) Inventors: Sungbae KIM, Yongin-si (KR); Gunho Kwak, Yongin-si (KR)

(21) Appl. No.: 13/193,893

(22) Filed: Jul. 29, 2011

Related U.S. Application Data
(60) Provisional application No. 61/431,516, filed on Jan. 11, 2011.

(51) Int. Cl. H01M 2/30; H01M 2/20; H01M 2/10

(52) U.S. Cl. 429/159; 429/179; 29/623.2

(57) ABSTRACT

A secondary battery, a method of assembling the same, and a battery pack including the secondary battery, the secondary battery including an electrode assembly; a collecting terminal electrically connected to the electrode assembly; a terminal plate electrically connected to the collecting terminal, the terminal plate including a slide groove on an upper side thereof; and a coupling terminal connected to the terminal plate, wherein the coupling terminal is slide-coupled with the slide groove of the terminal plate.

### CROSS-REFERENCE TO RELATED APPLICATION

The present application claims priority under 35 U.S.C. §119(e) to U.S. Provisional Application No. 61/431,516, filed on Jan. 11, 2011, and entitled: “Secondary Battery and Assembling Method Thereof,” which is incorporated herein by reference in its entirety.

### BACKGROUND

1. Field

Embodiments relate to a secondary battery, a method of assembling the secondary battery, and a battery pack including the secondary battery.

2. Description of the Related Art

Secondary batteries are rechargeable, unlike primary batteries. Among secondary batteries, a low capacity battery including a battery cell in the form of a pack may be used for small portable electronic devices, e.g., cellular phones and camcorders. A high capacity battery including dozens of battery cells connected to one another may be used as, e.g., a motor-driving power source for electric scooters, hybrid vehicles, or electric vehicles.

Secondary batteries may be manufactured in various shapes, e.g., a cylindrical shape, a prismatic shape, etc. A secondary battery may be manufactured as follows: an electrode assembly formed by disposing an insulating separator between a positive electrode plate and a negative electrode plate may be placed in a case together with electrolyte, and a cap plate may be disposed on the case. The electrode assembly may be connected to positive and negative terminals that protrude from the cap plate and are exposed to an exterior of the electrode assembly.

### SUMMARY

Embodiments are directed to a secondary battery, a method of assembling the secondary battery, and a battery pack including the secondary battery.

The embodiments may be realized by providing a secondary battery including an electrode assembly; a collecting terminal electrically connected to the electrode assembly; a terminal plate electrically connected to the collecting terminal, the terminal plate including a slide groove on an upper side thereof; and a coupling terminal connected to the terminal plate, wherein the coupling terminal is slide-coupled with the slide groove of the terminal plate.

The secondary battery may further include a collecting plate electrically connected between the collecting terminal and the electrode assembly.

The coupling terminal may include a bending part, the bending part being bent at lateral sides of the terminal plate.

The terminal plate may include coupling grooves at the lateral sides thereof, the bending part of the coupling terminal being coupled to the coupling grooves of the terminal plate.

The coupling grooves of the terminal plate may be on opposing lateral sides of the terminal plate.

The terminal plate may include fixing jaws on an upper side of the slide groove.

The coupling terminal may include a body part and an insertion part on a lower side of the body part, the insertion part being slide-coupled with the slide groove of the terminal plate.

A width and a thickness of the insertion part may correspond to a width and a thickness of the slide groove.

The coupling terminal may include a fixing part on an upper side of the insertion part, a width of the fixing part being smaller than a width of the insertion part.

The width of the fixing part may correspond to a distance between the fixing jaws of the terminal plate.

The coupling terminal may be welded to the terminal plate between the fixing part and the fixing jaws.

The bending part may be bent downwardly at an angle of about 90 degrees relative to an upper surface of the terminal plate.

The terminal plate may include a penetration hole in a center part thereof, the collecting terminal being in the penetration hole.

The embodiments may also be realized by providing a method of assembling a secondary battery, the method including coupling a collecting terminal to an electrode assembly; coupling a terminal plate to the collecting terminal, the terminal plate including a slide groove on an upper side thereof; and slide-coupling a coupling terminal to the terminal plate by inserting the coupling terminal into the slide groove of the terminal plate.

The coupling terminal may include a bending part at sides thereof, and slide-coupling the coupling terminal includes inserting the coupling terminal in the slide groove of the terminal plate in a state in which a first end of the bending part is bent downwardly and a second end of the bending part extends substantially parallel with an inserting direction of the coupling terminal.

Slide-coupling the coupling terminal may further include bending the second end of the bending part to couple the second end to a second lateral side of the terminal plate when the first end of the bending part contacts a first lateral side of the terminal plate.

Bending the second end of the bending part may include bending the second end of the bending part downwardly at an angle of about 90 degrees relative to an upper surface of the terminal plate.

The terminal plate may include coupling grooves on the first and second lateral sides thereof, and slide-coupling the coupling terminal may include coupling the first and second ends of the bending part with the coupling grooves.

The embodiments may also be realized by providing a battery pack including a plurality of secondary batteries, each secondary battery including an electrode assembly; a collecting terminal electrically connected to the electrode assembly; a terminal plate electrically connected to the collecting terminal, the terminal plate including a slide groove on an upper side thereof; and a coupling terminal connected to the terminal plate, wherein the coupling terminal is slide-coupled with the slide groove of the terminal plate; and a bus bar electrically connecting at least two of the secondary batteries, wherein the bus bar is electrically connected to the terminal plates of the at least two secondary batteries.

### BRIEF DESCRIPTION OF THE DRAWINGS

The embodiments will become more apparent to those of ordinary skill in the art by describing in detail exemplary embodiments with reference to the attached drawings, in which:

FIG. 1 illustrates a perspective view of a secondary battery according to an embodiment;

FIG. 2 illustrates a perspective view of the secondary battery and collecting terminals separated from the secondary battery of FIG. 1;

FIG. 3 illustrates a sectional view taken along line 14′ of FIG. 1;

FIG. 4 illustrates an enlarged view of portion A of FIG. 3;

FIG. 5 illustrates a sectional view taken along line 1141′ of FIG. 1;

FIG. 6 illustrates an enlarged perspective view of an electrode terminal of the secondary battery of FIG. 1;

FIG. 7 illustrates a perspective view of a method of coupling secondary batteries with bus bars according to an embodiment;

FIGS. 8a and 8b illustrate views showing a current path in the electrode terminal of the secondary battery of FIG. 1; and

FIGS. 9a through 9f illustrate stages in a method of assembling the secondary battery according to an embodiment.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the invention to those skilled in the art.

In the drawing figures, the dimensions of layers and regions may be exaggerated for clarity of illustration. It will also be understood that when a layer or element is referred to as being “on” another element, it can be directly on the other element, or intervening elements may also be present. Further, it will be understood that when an element is referred to as being “under” another element, it can be directly under, and one or more intervening elements may also be present. In addition, it will also be understood that when an element is referred to as being “between” two elements, it can be the only element between the two elements, or one or more intervening elements may also be present. Like reference numerals refer to like elements throughout.

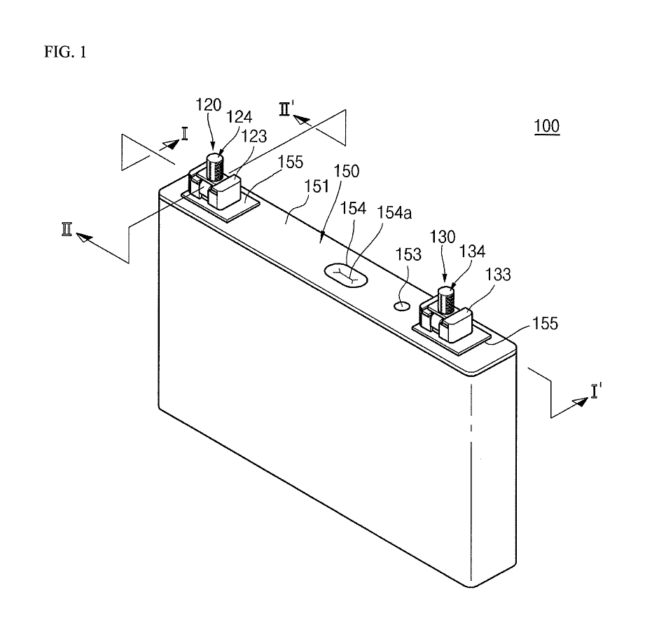

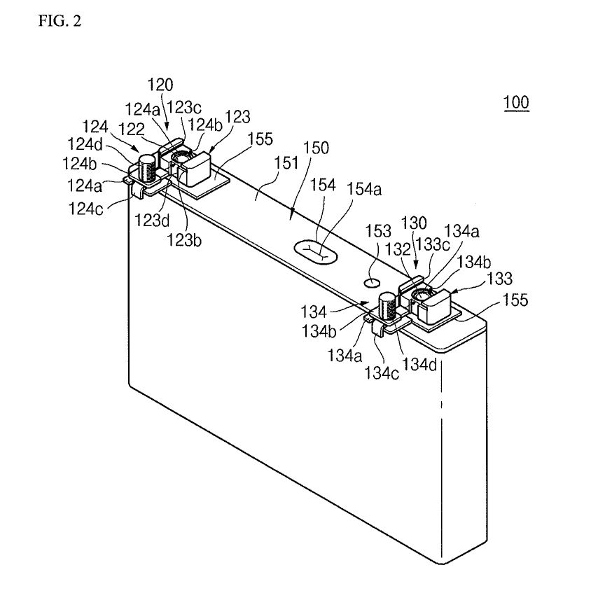

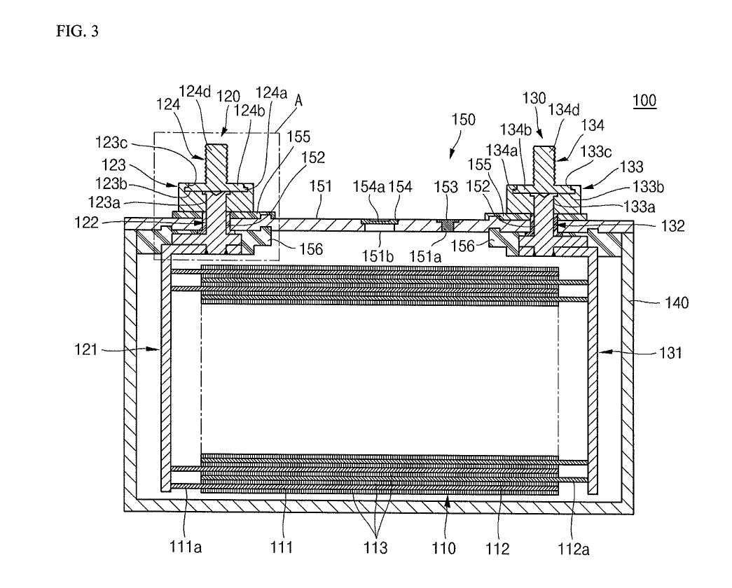

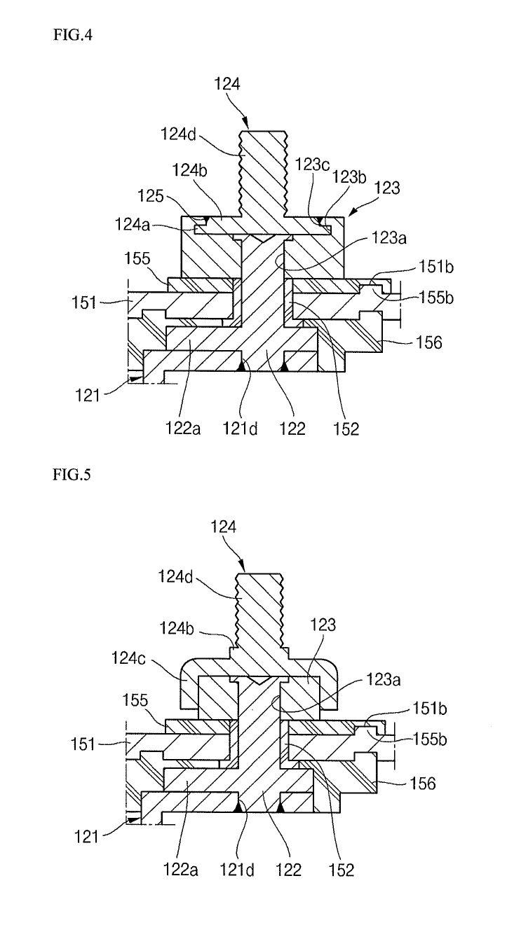

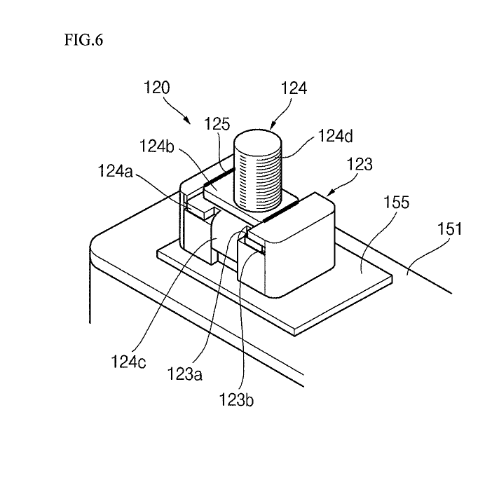

FIG. 1 illustrates a perspective view of a secondary battery according to an embodiment. FIG. 2 illustrates a perspective view of the secondary battery and collecting terminals separated from the secondary battery of FIG. 1. FIG. 3 illustrates a sectional view taken along line I-I′ of FIG. 1. FIG. 4 illustrates an enlarged view of portion A of FIG. 3. FIG. 5 illustrates a sectional view taken along line II-II′ of FIG. 1. FIG. 6 illustrates an enlarged perspective view of an electrode terminal of the secondary battery of FIG. 1.

Referring to FIGS. 1 through 6, a secondary battery 100 according to the present embodiment may include an electrode assembly 110, a first terminal 120, a second terminal 130, a case 140, and a cap assembly 150.

The electrode assembly 110 may be formed by winding or stacking a first electrode plate 111, a separator 113, and a second electrode plate 112 (which may have thin plate or film shapes). The separator 113 may be disposed between the first electrode plate 111 and the second electrode plate 112. In an implementation, the first electrode plate 111 may function as a negative electrode and the second electrode plate 112 may function as a positive electrode. In another implementation, the first electrode plate 111 and the second electrode plate 112 may have opposite polarities to those described above.

The first electrode plate 111 may be formed by applying a first electrode active material, e.g., graphite or carbon, to a first electrode collector formed of metal foil, e.g., nickel or copper foil. The first electrode plate 111 may include a first electrode non-coating portion 111a (to which the first electrode active metal is not applied). The first electrode non-coating portion 111a may function as a current flow passage between the first electrode plate 111 and an outside of the first electrode plate 111. In the embodiments, materials that may be used to form the first electrode plate 111 are not limited to the above-mentioned materials.

The second electrode plate 112 may be formed by applying a second electrode active material, e.g., a transition metal oxide, to a second electrode collector formed of metal foil, e.g., aluminum foil. The second electrode plate 112 may include a second electrode non-coating portion 112a (to which the second electrode active metal is not applied). The second electrode non-coating portion 112a may function as a passage for a current between the second electrode plate 112 and an outside of the second electrode plate 112. In the embodiments, materials that can be used to form the second electrode plate 112 are not limited to the above-mentioned materials.

The polarities of the first and second electrode plates 111 and 112 may be changed with each other, e.g., may be reversed depending on a charging/discharging condition.

The separator 113 may be disposed between the first electrode plate 111 and the second electrode plate 112 to prevent a short circuit and to facilitate movement of lithium ions. The separator 113 may be formed of, e.g., a polyethylene film, a polypropylene film, or a film including polyethylene and polypropylene. In the embodiments, materials that may be used to form the separator 113 are not limited to the above-mentioned materials.

Ends of the electrode assembly 110 may be coupled with the first and second terminals 120 and 130 that are electrically connected, respectively, to the first and second electrode plates 111 and 112.

The electrode assembly 110 may be accommodated in the case 140 together with electrolyte. The electrolyte may include an organic solvent, e.g., ethylene carbonate (EC), propylene carbonate (PC), diethyl carbonate (DEC), ethyl methyl carbonate (EMC), dimethyl carbonate (DMC), and the like; and a lithium salt, e.g., LiPF₆, LiBF₄, or the like. The electrolyte may be liquid, solid, or gel.

The first terminal 120 may be formed of a metal or an equivalent thereof, and may be electrically connected to the first electrode plate 111. The first terminal 120 may include a first collecting plate 121, a first collecting terminal 122, a first terminal plate 123, and a first coupling terminal 124.

The first collecting plate 121 may contact the first electrode non-coating portion 111a protruding from an end of the electrode assembly 110. In an implementation, the first collecting plate 121 may be welded to the first electrode non-coating portion 111a. The first collecting plate 121 may have an approximately reverse L-shape; and a terminal hole 121d may be formed in an upper part of the first collecting plate 121. The first collecting terminal 122 may be fitted in and coupled to the terminal hole 121d. In an implementation, the first collecting plate 121 may be formed of copper or a copper alloy. However, the material of the first collecting plate 121 is not limited thereto.

The first collecting terminal 122 may penetrate a cap plate 151 (described below) and may protrude upwardly by a predetermined length. The first collecting terminal 122 may be electrically connected to the first collecting plate 121 at a lower side of the cap plate 151. The first collecting terminal 122 may extend and protrude upwardly from the cap plate 151 by a predetermined length. The first collecting terminal 122 may include a flange 122a at a position under the cap plate 151 to prevent separation of the first collecting terminal 122 from the cap plate 151. A part of the first collecting terminal 122 lower than or under the flange 122a may be inserted in the terminal hole 121d of the first collecting plate 121 and may be welded to the first collecting plate 121. A part of the first collecting terminal 122 higher than or above the flange 122a may be fixed to the first terminal plate 123. For example, an upper end of the first collecting terminal 122 may be coupled to the first terminal plate 123 (described below) and may be fixed by, e.g., riveting. The first collecting terminal 122 may be electrically insulated from the cap plate 151. In an implementation, the first collecting terminal 122 may be formed of one of copper, copper alloy, and/or an equivalent thereof However, materials that may be used to form the first collecting terminal 122 are not limited thereto.

The first terminal plate 123 may include a body part, a penetration hole 123a formed vertically in the body part, a slide groove 123b formed horizontally in the body part, and fixing jaws 123c on an upper side of the slide groove 123b. The first terminal plate 123 may have an approximately hexahedral shape; and the penetration hole 123a may be formed at a center part of the first terminal plate 123 in an approximately vertical direction. The first collecting terminal 122 may be inserted through the penetration hole 123a.

The slide groove 123b may be horizontally formed in an approximately upper side of the first terminal plate 123 so that the first coupling terminal 124 may be inserted in, e.g., slide-coupled with, the slide groove 123b.

The fixing jaws 123c on the slide groove 123b may fix the first coupling terminal 124 in a vertical direction when the first coupling terminal 124 is slide-coupled with the slide groove 123b.

In addition, the first terminal plate 123 may include coupling grooves 123d on lateral sides thereof in a direction perpendicular to the slide groove 123b. In an implementation, the coupling grooves 123d may be on opposing lateral sides of the terminal plate 123. A bending part 124c (described below) of the first coupling terminal 124 may be coupled to the coupling grooves 123d. Accordingly, when the first coupling terminal 124 is coupled to the first terminal plate 123, a vertical and horizontal position of the first coupling terminal 124 may be fixed.

The first terminal plate 123 may be formed of, e.g., stainless steel, copper, copper alloy, aluminum, aluminum alloy, and/or an equivalent thereof. However, the embodiments are not limited to such materials. In an implementation, the first terminal plate 123 and the cap plate 151 may be insulated from each other.

The first collecting terminal 122 and the first terminal plate 123 may be coupled and fixed to each other. For example, the first collecting terminal 122 may be inserted through the penetration hole 123a of the first terminal plate 123; and the upper end of the first collecting terminal 122 may be deformed like a rivet. Thus, the first collecting terminal 122 and the first terminal plate 123 may be mechanically and electrically coupled to each other. The upper end of the first collecting terminal 122 may be on the same plane as the slide groove 123b of the first terminal plate 123 or may be at a position lower than the slide groove 123b. Accordingly, the slide-coupling of the first terminal plate 123 and the first coupling terminal 124 may not be hindered by the first collecting terminal 122.

The first coupling terminal 124 may be slid into the upper side of the first terminal plate 123, e.g., the first coupling terminal 124 may be slide-coupled with the first terminal plate 123, and may be fixed thereto. The first coupling terminal 124 may include a body part and insertion parts 124a on a lower side of the body part. A width and a thickness of the insertion parts 124a may correspond to a width and a thickness of the slide groove 123b. The insertion parts 124a may be inserted into the first terminal plate 123 in a manner such that the insertion parts 124a are horizontally slid into the slide groove 123b of the first terminal plate 123, i.e., slide-coupled.

In addition, the first coupling terminal 124 may include a fixing part 124b on upper sides of the insertion parts 124a. A width of the fixing part 124b may be smaller than a width of the insertion parts 124a. The width of the fixing part 124b may correspond to a distance between the fixing jaws 123c. The fixing part 124b may be slid between the fixing jaws 123c, thereby fixing a vertical position of the insertion parts 124a by the fixing jaws 123c.

In addition, the first coupling terminal 124 may include the bending part 124c between the insertion parts 124a. The bending part 124c may be disposed between the insertion parts 124a at front and rear sides in a direction along which the insertion parts 124a are inserted into the slide grooves 123b of the first terminal plate 123. After the first coupling terminal 124 is inserted into the slide groove 123b of the first terminal plate 123, the bending part 124c may be bent downward at lateral sides of the first terminal plate 123 toward the first terminal plate 123 at an angle of approximately 90 degrees relative to an upper surface of the first terminal plate 123. Then, in the sliding direction of the first coupling terminal 124, the front and rear sides of the first coupling terminal 124 may be fixed by the bending part 124c. For example, the bending part 124c may be coupled to the coupling grooves 123d in the first terminal plate 123. Thus, after the bending part 124c is coupled to the coupling grooves 123d, movement of the front and rear sides of the first coupling terminal 124 may be prevented, e.g., the horizontal position of the first coupling terminal 124 may be fixed. In an implementation, the coupling terminal 124 may be welded at a weld 125 to the terminal plate 123 between the fixing part 124b and the fixing jaws 123c.

In addition, the first coupling terminal 124 may include a terminal part 124d protruding upwardly from the fixing part 124b. A screw thread may be formed on the terminal part 124d for coupling a bus bar to the terminal part 124d.

The first coupling terminal 124 may be formed of, e.g., stainless steel, copper, copper alloy, aluminum, aluminum alloy, and/or an equivalent thereof. However, the embodiments are not limited to such materials.

The second terminal 130 may be formed of a metal or an equivalent thereof, and may be electrically connected to the second electrode plate 112. The second terminal 130 may include a second collecting plate 131, a second collecting terminal 132, a second terminal plate 133, and a second coupling terminal 134. The second terminal 130 may have substantially the same structure as that of the first terminal 120. Thus, a repeated detailed description thereof is omitted. The second collecting plate 131 and the second collecting terminal 132 may be formed of, e.g., aluminum, an aluminum alloy, and/or an equivalent thereof. However, the embodiments are not limited to such materials. The second terminal plate 133 and the second coupling terminal 134 may be formed of, e.g., stainless steel, aluminum, aluminum alloy, copper, copper alloy, and/or an equivalent thereof. However, the embodiments are not limited thereto.

In addition, the second terminal plate 133 may be electrically connected to the cap plate 151. In this case, the case 140 and the cap plate 151 (that will be described below in detail) may have the same polarity, e.g., positive polarity, as that of the second terminal 130.

The case 140 may be formed of a conductive metal, e.g., aluminum, aluminum alloy, or steel plated with nickel. The case 140 may have an approximately hexahedral shape with an opening so that the electrode assembly 110, the first terminal 120, and the second terminal 130 may be inserted and placed in the case 140. FIG. 3 illustrates a state where the case 140 and the cap assembly 150 are coupled to each other, and the opening of the case 140 is not shown. However, a peripheral part of the cap assembly 150 may substantially correspond to the opening of the case 140. An inner surface of the case 140 may be treated to be electrically insulated from the electrode assembly 110, the first and second terminals 120 and 130, and the cap assembly 150.

The cap assembly 150 may be coupled to the case 140. For example, the cap assembly 150 may include the cap plate 151, sealing gaskets 152, a plug 153, a safety vent 154, first insulation members 155, and second insulation members 156. The sealing gaskets 152, the first insulation members 155, and the second insulation members 156 may be considered as elements of the first and second terminals 120 and 130.

The cap plate 151 may close or seal the opening of the case 140. The cap plate 151 may be formed of the same material as that used to form the case 140. In an implementation, the cap plate 151 may be coupled to the case 140 by, e.g., laser welding. As described above, the cap plate 151 may have the same polarity as that of the second terminal 130. In this case, the cap plate 151 and the case 140 may have the same polarity.

The sealing gaskets 152 may be formed of an insulating material and may be disposed between the cap plate 151 and the first and second collecting terminals 122 and 132 to seal the gaps between the cap plate 151 and the first and second collecting terminals 122 and 132. The sealing gaskets 152 may prevent permeation of moisture into the secondary battery 100 and/or prevent leakage of the electrolyte from the secondary battery 100.

The plug 153 may close an electrolyte injection hole 151a of the cap plate 151. The safety vent 154 may be disposed on a vent hole 151b of the cap plate 151, and a notch 154a may be formed in the safety vent 154 so that the safety vent 154 may be opened at a predetermined pressure.

The first insulation members 155 may be disposed between the cap plate 151 and the first and second terminal plates 123 and 133. In addition, the first insulation members 155 may closely contact the cap plate 151. Furthermore, the first insulation members 155 may closely contact the sealing gaskets 152. The first insulation members 155 may insulate the cap plate 151 from the first and second terminal plates 123 and 133.

The second insulation members 156 may be disposed between the cap plate 151 and the first and second collecting plates 121 and 131 to prevent an unnecessary and undesirable short circuit. For example, the second insulation members 156 may prevent a short circuit between the first collecting plate 121 and the cap plate 151 and a short circuit between the second collecting plate 131 and the cap plate 151. The second insulation members 156 may also be disposed between the cap plate 151 and the first and second collecting terminals 122 and 132 so that a short circuit may be prevented between the cap plate 151 and the first and second collecting terminals 122 and 132.

As described above, according to the present embodiment, the terminals 120 and 130 of the secondary battery 100 may be configured such that the vertical positions of the coupling terminals 124 and 134 relative to the terminal plates 123 and 133 may be fixed by slide-coupling the coupling terminals 124 and 134 into the terminal plates 123 and 133 in a state where the collecting terminals 122 and 132 are fixed to the terminal plates 123 and 133 by, e.g., riveting. In addition, the horizontal positions of the coupling terminals 124 and 134 may be fixed by bending the bending parts 124c and 134c. Accordingly, the coupling terminals 124 and 134 may be firmly and reliably coupled to the terminal plates 123 and 133. Thus, electrical resistance may be advantageously reduced. Furthermore, an additional welding process may not be necessary. Thus, assembly may be easily carried out.

Hereinafter, current passages in electrode terminals of secondary batteries will be described according to embodiments.

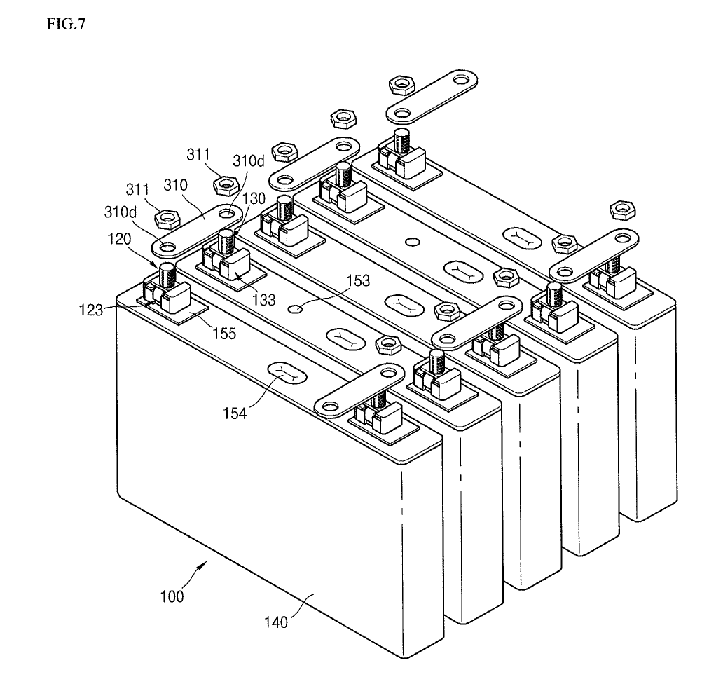

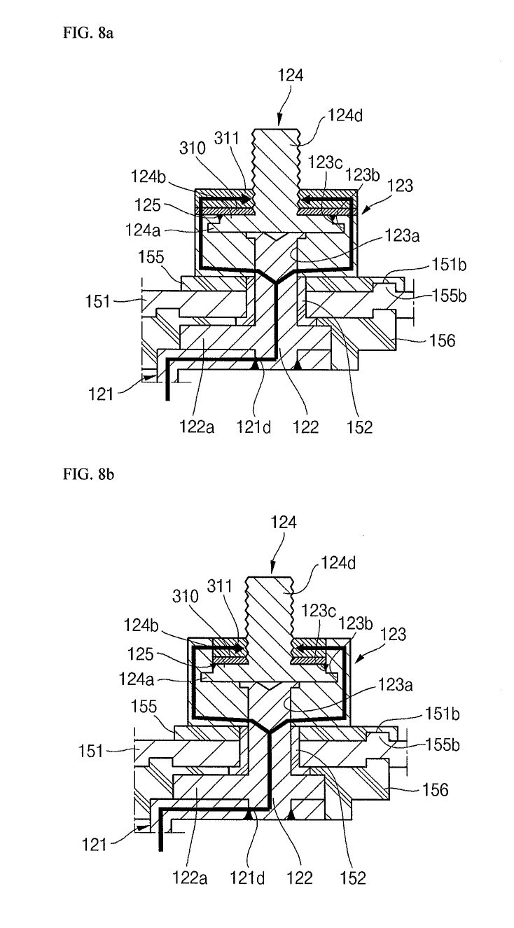

FIG. 7 illustrates a perspective view of a method of coupling secondary batteries with bus bars according to an embodiment. FIGS. 8a and 8b illustrate views of a current path in the electrode terminal of the secondary battery of FIG. 1. In FIGS. 8a and 8b, arrows denote passages of discharge current.

Referring to FIGS. 7 and 8a, bus bars 310 may be coupled to the coupling terminals 124 of at least two of the secondary batteries 100 to assemble a battery pack. For example, the coupling terminals 124 may be coupled to penetration holes 310d of the bus bars 310. Then, nuts 311 may be coupled to portions of the coupling terminals 124 higher than or above the bus bars 310 so that the bus bars 310 may be brought into tight or close contact with terminal plates 123. Accordingly, the terminal plates 123 having a relatively large area may be disposed between the collecting terminals 122 and the bus bars 310. Thus, current passages may be increased and electric contact resistance may be reduced. Referring FIG. 8b, the bus bars 310 and the nuts 311 may be coupled to the terminal plates 123 at an inner position of the fixing jaws 123c.

The bus bars 310 may be formed of, e.g., stainless steel, aluminum, aluminum alloy, copper, copper alloy, and/or an equivalent thereof However, the embodiments are not limited to such materials.

As described above, the terminal plates 123 and 133 and the coupling terminals 124 and 134 may be formed of the same material or different materials. In addition, the terminal plates 123 and 133 and the bus bars 310 may be formed of the same material or different materials. In the secondary battery 100 of the present embodiment, the collecting terminals 122 and 132 may be coupled to the terminal plates 123 and 133 by, e.g., riveting. The coupling terminals 124 and 134 may be slide-coupled with the slide grooves 123b and 133b of the terminal plates 123 and 133, and the bending parts 124c and 134c may be bent. Thus, a position of the coupling terminals 124 and 134 may be securely fixed. Furthermore, the bus bars 310 may be coupled to the coupling terminals 124 and 134 by using the nuts 311. Thus, a large increase in electric resistance may be prevented, even though different materials are coupled.

Hereinafter, a method of assembling the secondary battery according to an embodiment will be described.

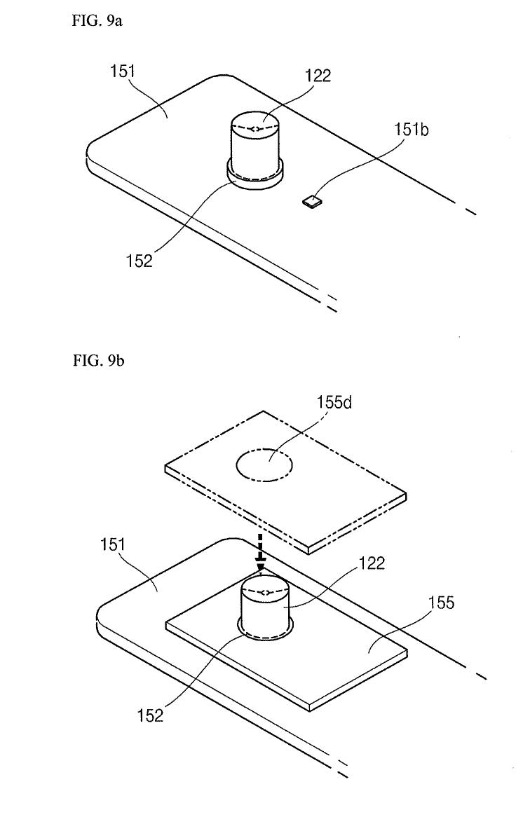

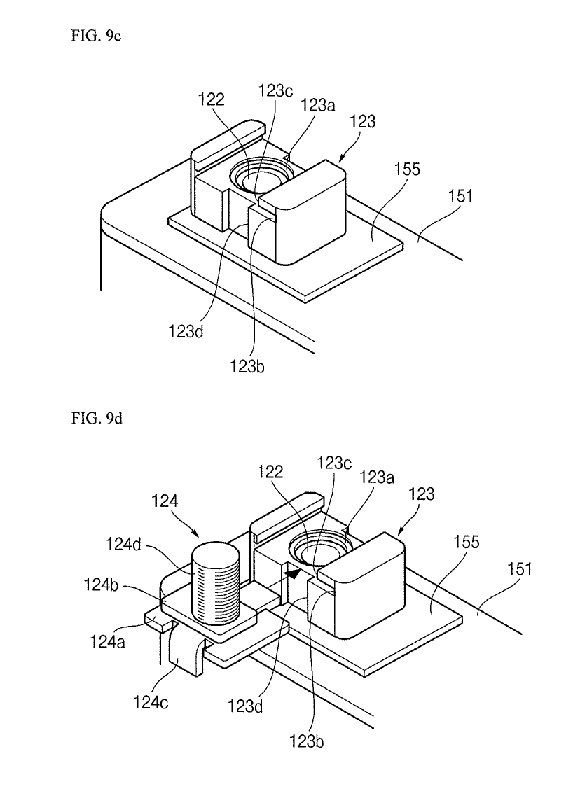

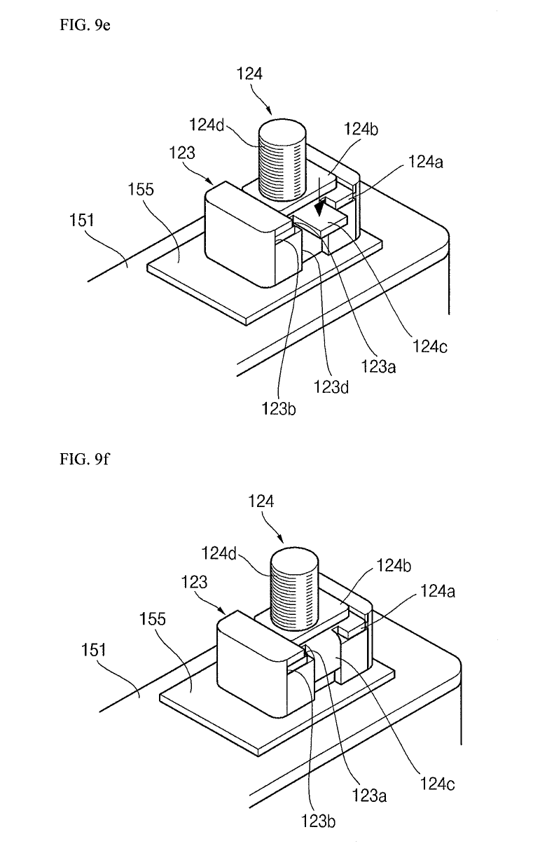

FIGS. 9a through 9f illustrate stages in a method of assembling the secondary battery according to an embodiment.

As shown in FIG. 9a, the first collecting terminal 122 may be coupled to the cap plate 151, e.g., may pass through a hole in the cap plate 151. The first collecting terminal 122 may be electrically insulated from the cap plate 151 by using the sealing gasket 152. The cap plate 151 may include a protrusion 151b that will be coupled to a hole of the first insulation member 155.

As shown in FIG. 9b, the first insulation member 155 may be coupled to the first collecting terminal 122. For example, the first collecting terminal 122 may be inserted through a penetration hole 155d formed through the first insulation member 155.

Then, the first insulation member 155 may be placed on the cap plate 151 and coupled with the protrusion 151b. Thus, rotation of the first insulation member 155 on the first collecting terminal 122 may be prevented. The first collecting terminal 122 inserted through the first insulation member 155 may protrude upwardly from the first insulation member 155.

As shown in FIG. 9c, the first terminal plate 123 may be coupled to the first collecting terminal 122. For example, the first collecting terminal 122 may be inserted in the penetration hole 123a in the center part of the first terminal plate 123. Accordingly, the first terminal plate 123 may be brought into tight or close contact with the first insulation member 155. Thus, the first terminal plate 123 may be electrically insulated from the cap plate 151.

In addition, the upper end of the first collecting terminal 122 may be deformed by using a riveting tool. The upper end of the first collecting terminal 122 may be deformed toward a groove formed around the penetration hole 123a of the first terminal plate 123 by using the riveting tool. After the riveting process, the upper end of the first collecting terminal 122 may be at a position lower than the slide groove 123b of the first terminal plate 123. Thus, slide-coupling of the coupling terminal 124 may not be hindered in a later process.

As shown in FIG. 9d, the first coupling terminal 124 may be slide-coupled with the first terminal plate 123. For example, the bending part 124c of the first coupling terminal 124 may be prepared in a state where one end, e.g., a first end, of the bending part 124c is bent downward at about 90 degrees relative to an upper surface of the first terminal plate 123 and another end of the bending part 124c may be horizontal and parallel with the insertion parts 124a. In this state, the non-bent horizontal end, e.g., a second end, of the bending part 124c of the first coupling terminal 124 may be oriented toward the slide groove 123b; and the insertion parts 124a of the first coupling terminal 124 may be inserted and slid into the slide groove 123b of the first terminal plate 123, e.g., may be slide-coupled therewith. For example, the second end of the bending part 124c may extend substantially parallel with an inserting direction of the first coupling terminal 124. The first coupling terminal 124 may be slid into the slide groove 123b until the rear bent end of the bending part 124c is coupled to the coupling groove 123d of the first terminal plate 123. At this time, due to the fixing jaws 123c of the first terminal plate 123, the upper sides of the insertion parts 124a of the first coupling terminal 124 may be restricted in upward or vertical movement. Thus, the vertical position of the first coupling terminal 124 may be fixed.

As shown in FIGS. 9e and 9f, the front horizontal end of the bending part 124c may be bent at about 90 degrees by using, e.g., a press. The bent end of the bending part 124c may be coupled to the coupling groove 123d of the first terminal plate 123. Both front and rear ends of the bending part 124c of the first coupling terminal 124 may be bent at about 90 degrees and may be coupled to the first terminal plate 123. Thus, the horizontal position of the first coupling terminal 124 may be fixed.

According to the embodiments, the terminals of the secondary battery may be configured such that the vertical positions of the coupling terminals may be fixed by slide-coupling the coupling terminals into the terminal plates; and the horizontal positions of the coupling terminals may be fixed by bending the bending parts of the coupling terminals. Therefore, the coupling terminals may be firmly coupled to the terminal plates, thereby improving coupling reliability and reducing resistance and manufacturing costs.

In addition, according to the embodiments, the secondary battery may be securely coupled without an additional welding process. Thus, the secondary battery may be assembled more easily.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A secondary battery, comprising:
an electrode assembly;
a collecting terminal electrically connected to the electrode assembly;
a terminal plate electrically connected to the collecting terminal, the terminal plate including a slide groove on an upper side thereof; and
a coupling terminal connected to the terminal plate, wherein the coupling terminal is slide-coupled with the slide groove of the terminal plate.

2. The secondary battery as claimed in claim 1, further comprising a collecting plate electrically connected between the collecting terminal and the electrode assembly.

3. The secondary battery as claimed in claim 1, wherein the coupling terminal includes a bending part, the bending part being bent at lateral sides of the terminal plate.

4. The secondary battery as claimed in claim 3, wherein the terminal plate includes coupling grooves at the lateral sides thereof, the bending part of the coupling terminal being coupled to the coupling grooves of the terminal plate.

5. The secondary battery as claimed in claim 4, wherein the coupling grooves of the terminal plate are on opposing lateral sides of the terminal plate.

6. The secondary battery as claimed in claim 1, wherein the terminal plate includes fixing jaws on an upper side of the slide groove.

7. The secondary battery as claimed in claim 6, wherein the coupling terminal includes a body part and an insertion part on a lower side of the body part, the insertion part being slide-coupled with the slide groove of the terminal plate.

8. The secondary battery as claimed in claim 7, wherein a width and a thickness of the insertion part correspond to a width and a thickness of the slide groove.

9. The secondary battery as claimed in claim 7, wherein the coupling terminal includes a fixing part on an upper side of the insertion part, a width of the fixing part being smaller than a width of the insertion part.

10. The secondary battery as claimed in claim 9, wherein the width of the fixing part corresponds to a distance between the fixing jaws of the terminal plate.

11. The secondary battery as claimed in claim 6, wherein the coupling terminal is welded to the terminal plate between the fixing part and the fixing jaws.

12. The secondary battery as claimed in claim 1, wherein the bending part is bent downwardly at an angle of about 90 degrees relative to an upper surface of the terminal plate.

13. The secondary battery as claimed in claim 1, wherein the terminal plate includes a penetration hole in a center part thereof, the collecting terminal being in the penetration hole.

14. A method of assembling a secondary battery, the method comprising:
coupling a collecting terminal to an electrode assembly;
coupling a terminal plate to the collecting terminal, the terminal plate including a slide groove on an upper side thereof; and
slide-coupling a coupling terminal to the terminal plate by inserting the coupling terminal into the slide groove of the terminal plate.

15. The method as claimed in claim 14, wherein:
the coupling terminal includes a bending part at sides thereof, and
slide-coupling the coupling terminal includes inserting the coupling terminal in the slide groove of the terminal plate in a state in which a first end of the bending part is bent downwardly and a second end of the bending part extends substantially parallel with an inserting direction of the coupling terminal.

16. The method as claimed in claim 15, wherein slide-coupling the coupling terminal further includes bending the second end of the bending part to couple the second end to a second lateral side of the terminal plate when the first end of the bending part contacts a first lateral side of the terminal plate.

17. The method as claimed in claim 16, wherein bending the second end of the bending part includes bending the second end of the bending part downwardly at an angle of about 90 degrees relative to an upper surface of the terminal plate.

18. The method as claimed in claim 16, wherein:
the terminal plate includes coupling grooves on the first and second lateral sides thereof, and slide-coupling the coupling terminal includes coupling the first and second ends of the bending part with the coupling grooves.

19. A battery pack, comprising:
a plurality of secondary batteries, each secondary battery including:
an electrode assembly;
a collecting terminal electrically connected to the electrode assembly;
a terminal plate electrically connected to the collecting terminal, the terminal plate including a slide groove on an upper side thereof; and
a coupling terminal connected to the terminal plate, wherein the coupling terminal is slide-coupled with the slide groove of the terminal plate; and
a bus bar electrically connecting at least two of the secondary batteries, wherein the bus bar is electrically connected to the terminal plates of the at least two secondary batteries.
